(19) United States
(12) Patent Application Publication
(10) Pub. No.: US 2003/0024156 A1
(43) Pub. Date: Feb. 6, 2003

(54) Squirrel combaton

(76) Inventor: Robert H. Tinshey, Denver, CO (US)

Correspondence Address: Robert H. Tinsley, 2452 LaFayette St., Denver, CO, 80205, US

(21) Appl. No.: 09/941,802

(22) Filed: Jan. 28, 2002

Related U.S. Application Data
(60) Provisional application No. 60/229,057, filed on Aug. 31, 2000.

(51) Int. Cl. A01G 13/02

(52) U.S. Cl. 47/32.5

(57) ABSTRACT

A effective device, providing 24 hours, 7 day per week protection and control of small tree nesting animals infestation in a commercial or residential setting. The SQUIRREL COMBATON is a simple, two foot by six foot, 0.025 gauge rectangular-shaped aluminum panel strategically secured on the trunk of the tree The combined effect of the camouflaging tree pattern and the presentation of the “Owl Eyes” simulation onto the panel would remain unnoticed by those passers-by and doubles the effectiveness of the device. The flexibility of this product would enable it to be easily wrapped around the tree, but at the same time it would be durable enough to tightly hold its form around the tree. It would also be weatherproof, and able to be used during all four seasons. Thus a considerably most effective and versatile tree shield/guard in simplicity and utility.

### STATEMENT REGARDING FEDERALLY SPONSORED RESEARCH AND DEVELOPMENT

not applicable

### REFERENCE TO A MICROFICHE APPENDIX

not applicable

### BACKGROUND OF THE INVENTION

This invention relates to tasteful and humanely providing environmental control of small wild tree nesting animals infestation which can cause damage to foliage and trees in a commercial or residential setting. For many families, it is enjoyable to see a squirrel scampering around on their property while hunting for food. The presence of the squirrel might make them feel closer to nature and some of its actions amusing. However, the same squirrel might also be climbing up and down trees planted in the yard. The movement and actions of squirrels might damage the trees, which could negatively affect their health and diminish the overall appearance of the landscape.

The SQUIRREL COMBATON is a simple, yet very effective device, developed and designed in principle to humanely prevent squirrels from being able to access the upper portion of a tree, where damage and defoliate occurs. Prior devices have been developed utilizing hybrid concepts of passage-barrier methods. That is, passage-barrier designs were developed and constructed around the concept of a ground-level barrier. The ground-level barrier was stated to be one of the most effective means of defoliate protection was to totally deny passage to the tree. Hybrid in design, ground-level barrier structures had many issues to contend with, beyond its intended utilization. And in certain situations, newer devices corrected issues or suggested other use-form from prior devices.

Wrapping a sapling with a protective covering and encasing both the sapling and the protective covering into a fenced protective area within a metal bracket supported cylindrical area. This was fine until squirrels were timed to run at the speed of four feet per second and at that speed, capable of jumping even greater distances. Or that the squirrels can climb on wire mesh or perforated metal cylindrical shaped objects. Or that although not a ground-dwelling animal but has been known to tunnel passage to the tree underground when blocked. Compounding this situation was the issue when a metal object is placed as to abuts ground-level soil contact, you have some type of corrosion factor from moisture and oxidation decay of metal.

To compensate for this corrosion factor, prior art had four hollow triangular footings used as anchors on above ground-barriers secured at the bottom of the cylindrical created. The design partially buried the anchors below ground-level and formed four small uncapped water reservoirs in which stored water would slowly seep into the saplings root system. However, the sight of the collection of debris caught between the protective fence mesh on a ground-level barrier during a typical windy day, as well as the view of a forest of painted white, red or green color cylindrical shaped devices provided no visual appeal.

The concept of above ground-level barriers were not routinely employed in devices, due to the complexities of attachment for tree collars and bare-metal platform that stood out from the tree, as on the platform design, where the tree to metal circumferential-ring barrier extended outward away from the trunk or branch to a distance of twenty-four inches or greater than the girth of the tree or branch.

This simple, two foot by six foot, 0.025 gauge rectangular-shaped aluminum panel would be strategically placed on the trunk/branch of a tree approximately eight to ten feet above ground. Placement for the trunk of the tree is ideally situated just before the first twist or bend in the tree approximately eight feet above ground level.

The ideal attachment to the branch is approximately ten feet above ground-level where the branches hang at an angle of 45 degree to 90 degree in relation to the ground. The thought for the detail in angle is that squirrels creep up and down in an out stretched low body position at these angulations. Lowering their center of gravity, this posture certainly aids in their balance. Climbing up or down the tree in this lowered body posture, the animal would be challenged, to jump up and beyond the area of tree/branch covered by the device.

This device would be simply attached to the tree/branch at the suggested height and angulations, by anchoring the first three starter pre-punched holes located on the two foot side (1×1), (1×12) and (1×23)* (Due to the devise being flat, the description enclosed in brackets above, stand for x and y coordinates with a “X” to separate the values, with the total area of the panel converted to inches, valuation relating from one to seventy-two inches, left to right, separated by the “X” and the y-valuation relating from one to twenty-four inches, bottom to top) of the panel and continue to curl the remainder of panel around the base of the trunk or branch of the tree. The flexibility of this product would enable it to be easily wrapped around the tree, but at the same time it would be durable enough to tightly hold its form around the tree. It would also be weatherproof, and able to be used during all four seasons.

Once positioned, the smooth metallic surface of the shield would prevent the squirrels from gripping the bark and scurrying up the tree. Since the squirrels could not climb up into the tree, they would not damage it. Therefore, the health and the appearance of the tree would be maintained. With the tree intact and without damage, it would maintain the highest economic value.

Apart from its practical benefits, the SQUIRREL COMBATON would have an aesthetic appeal as well. The consideration of the four-color ink silk screening adhered to the smooth metallic outer surface of this panel could be produced to match the texture and coloration of the bark of the tree to which the product is attached. The silk screened smooth metallic outer surface panel when attached to the tree/branch, would be almost completely camouflaged, remaining unnoticed by those passers-by.

Another consideration that can be applied to our SQUIRREL COMBATON device during the four-color ink silk screening process, would consist of a pair of reproduced “Owl Eyes” simulations painted strategically on opposite ends of the six foot patterned panel. This reproduced “Owl Eyes” simulations does alert the squirrels and has prevented the squirrels from gripping the bark and scurrying up the tree. When made aware of the of the Owl Eyes, the squirrels remain in a very lowering posture, their body in an out-stretched manner, lowering their center of gravity. This posture certainly aids in their balance and readiness to flee. Climbing up or down the tree in this lowered body posture, the animal would be challenged, to jump up and beyond the area of tree/branch covered by the device.

Attempts have been made in the prior art at using physical barriers to prevent the tree climbing animals from passing from ground level to the upper part of the tree. However, these devices have been found to be marginally effective, due to the animals ability to see the physical barrier and to avoid the obstacle. Single color and multi-colored patterns have been applied to these ground level barriers in order to preserve continuity of appearance.

Many of the prior art devices are cylindrical-shaped barriers protecting the tree trunk from approximately ground level to three feet above ground level while enclosing the portion of the tree within a protected fence. The optimum placement requirement for maximum effectiveness for this SQUIRREL COMBATON is above ground-level. The optimum effective height placement for our SQUIRREL COMBATON is above ground-level, approximately eight to ten feet. The outer margin of the guard at eight to ten foot presents the climbing animal with difficult footing and hold thereby making it more difficult to pass the device.

Prior art, such as those filed Patent's listed above and are discussed in further detail below.

The U.S. Pat. No. 1,879,813, The Molitor patent, filed in 1929, as the Tree Protector, had an disclosure of having simple construction, inexpensive to manufacture and therefore providing an economical means of protecting young saplings trees against grazing animals, rabbits, mice or other rodents. It also was said to prevent overheating around the trees, blistering of the bark of the tree inside of the guard It claimed to be comprised of a perforated mesh-like one-piece body portion and a pair of anchoring rods, the ends of said body portion being severally wrapped around said anchoring rods and integrally and rigidly secured thereto, said anchoring rods projecting from one end of the said body portion, and a plurality of hook-like connecting members adapted to engage through the mesh about the adjacent rod to thereby connect said rods and the ends of said body portion to form an annular protector.

Although U.S. Pat. No. 1,879,813 is considered to be a very relevant prior art which performs a function similar in utilization, however the distinction is the structure and considerations made upon the product.

The U.S. Pat. No. 5,581,935, the Anderson patent, filed in 1996, as the Tree Protector, had a two step approach to prevent damage of young trees by grazing animals, such as cattle. The first component is a freely rotatable, perforated cylinder that surrounds the trunk of the tree. The second component is a ring that rests on the ground and surrounds the tree. The ring contains cavities larger than the feet of cattle and prevents cattle from stepping on the ring and getting close enough to eat the leaves or rub their bodies against the trunk. This tree protector included an artful aesthetically pleasing aspects when in place. The perforated-cylindrical portion of the first component, covering the lower 12 to 24 inches could be made of colors that blend with the natural colors of the tree and pasture or it can be made a color such as white to complement white fences and buildings in the vicinity of the pasture.

U.S. Pat. No. 5,581,935 is also relevant prior art that performs a similar function. Again, the distinction is the structure and method of use.

The art of camouflaging or blending into the background is an extremely essential point with our SQUIRREL COMBATON device. Visual appeal of prior art devices has risen from a plain coat of white, red, or green paint on the cylinder, to that of a four color ink, silk-screening of a tree bark pattern with the predator eyes adhered to outer surface of panel.

Des. Pat. No. 368,835, the Weber patent, filed in 1996, as a Tree Protector, disclosed a design for a tree protector, cylindrical, with four anchors on bottom, and a series of three circular cutouts, two towards bottom of cylinder and two above the midline of cylinder. The protector is typically left in position for several years as the tree grows.

Des. Pat. No. 368,835 is also relevant prior art. However, method of attachment and duration of treatment is the distinction.

U.S. Pat. No. 2,999,479, the Carder patent, filed in 1961, as a Animal Restraining Tree Guard, discloses that this invention embodies a guard designed for positioning around the trunk of a tree, the guard being so constructed and arranged that it will act as a barrier against reptiles or tree climbing animals from disturbing the birds nest in which eggs or young birds are contained. An important object of the invention was to provide a guard of this character which may be readily and easily positioned around the trunk or limb of a tree, the construction of the guard such that it will automatically adjust itself on the tree trunk or limbs of tree of various diameters.

U.S. Pat. No. 2,999,479 is relevant to the present invention in function. However, it does not share in structure or artful design of the present invention.

U.S. Pat. No. 4,637,164, the Brown Patent, filed in 1987, as a Squirrel Guard, disclosed that this invention relates to the environmental control of squirrels and similar animals which cause damage to foliage and growing materials, particularly trees. The invention has the capability of preventing the passage of small climbing animals from reaching the upper portion of a tree. Animals that nest in trees, create a serious problem in various areas such as commercial orchards, nurseries as well as domestic green belts areas/landscapes. These animals very often nest and feed on the leafs and fruits/nuts. The damage can be quite serious depending on the amount of infestation. From an economic standpoint alone, squirrels can rapidly strip a nut tree leaving nothing available for the grower to market. The use of chemical agents such as pesticides has not always been an effective solution. The pesticides must be continually applied, are quite expensive and very often cause more damage to the surrounding environment, not to mention the human population, than to the rodent at which it is directed.

Attempts have been made in the prior art at using physical barriers to prevent the tree climbing animals from nesting into the upper part of the tree. However, these devices have been found to be marginally effective, due to the animals ability to see and avoid the barrier-obstacle. Single color or multi-colored patterns have been applied to these barrier in order for continuity of appearance, as the devices covered sight of the tree trunk, ground level to three feet above ground.

All prior art noted above, U.S. Pat. Nos. 1,879,813, and 5,581,935, Des. Pat. No. 368,835; U.S. Pat. Nos. 2,999,479; 4,637,164, and 1,764,442 all illustrates devices which perform a similar function. There are still many structural differences between the present invention, SQUIRREL COMBATON, and prior related art whether considered singularly or in combination with each other.

Many of the prior art devices are cylindrical shaped barriers protecting the tree trunk from approximately ground level to three or four feet above ground level while two prior art disclosed optimum heights requirement for maximum effectiveness. The optimum effective height is above ground level, approximately eight to ten feet, for small climbing animals.

### CLAIMS AND SUMMARY OF THE INVENTION

It is, therefore, a claim of this invention to provide an animal guard for attachment to tree trunks/branches which is provided with an four color ink silk screened representation of a distinctive tree pattern design that allows a single device to be used with a wide range of tree species and their respective bark designs.

It is another claim of this invention to effectively reduce the footing and gripping action of an animal attempting to overcome such a barrier by usage of branch angulation and the presentation of a pair of “Owl Eyes” simulation in the silk screen tree bark design

A further claim of this invention is to provide a relatively simple and easily manufactured device that be left on year round, and does not hurt the growth of the tree.

Another claim of this invention is that it offers adjustable fit, and can accommodate a variety of tree girths, in six foot sections and is very low maintenance, yet weather proof and durable.

To summarize this invention, it related to an animal guard for tree trunks and branches comprising a rectangular shaped aluminum sheet metal panel two feet high, and six feet in length, at a optimum effective spacing 8-10 feet above ground-level. The prepared aluminum panel would be curled around the trunk or branch of the tree, at the specified height and secured with twelve ¾ inch long anchoring nails (copper/nickel alloy), each of which are secured so as to integrally connect the same with the panel and thereby rigidly connecting the nails to the body of the guard.

### DRAWINGS

FIG. 1 is a perspective top/pattern side up view in accordance with the invention, showing the simplicity of the concept.

FIG. 2 is a perspective top/pattern side up view in accordance with the invention, showing the simplicity of the concept, naming and referencing each of the twelve precut ⅛″ holes for attachment of each copper/nickel alloy nail to secure panel to tree trunk/branch.

FIG. 3 is a frontal view following the strategic placement on the trunk/branch of a tree

FIG. 4 is a perspective view of the copper/nickel alloy nail used to secure the panel to the living tree.

### DESCRIPTION

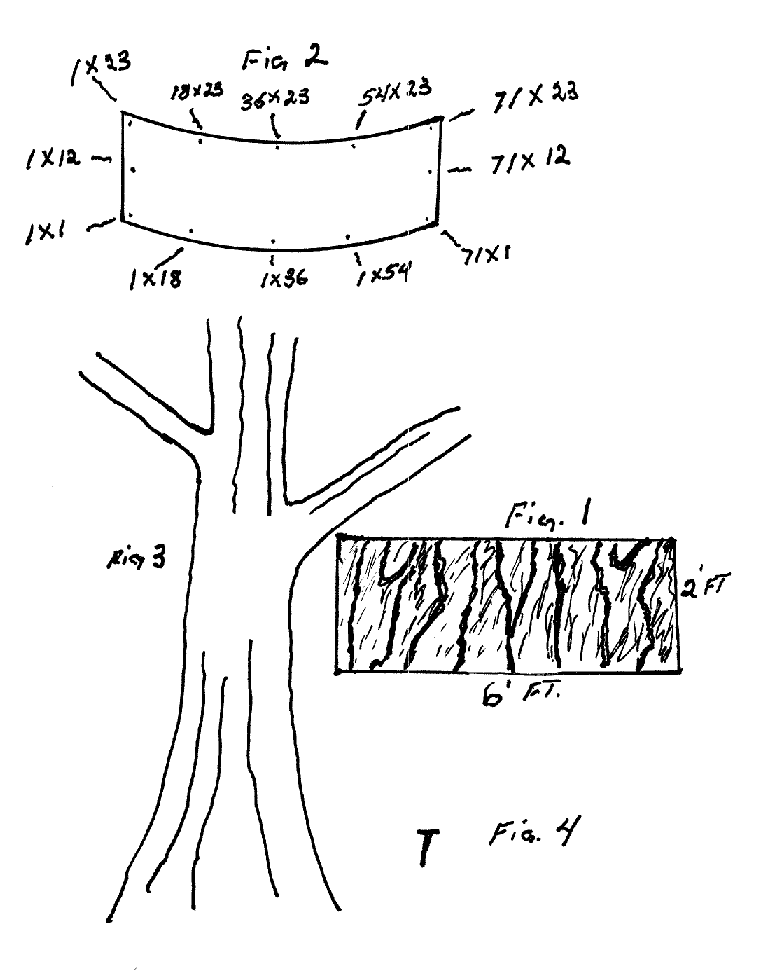

FIG. 1 is a perspective top/pattern side up view in accordance with the invention, showing the simplicity of the concept. The reverse non-printed side of panel also follows the same format for attachment to the tree trunk/branch.

FIG. 2 is a top/pattern side done view to show the actual scale used to attach this flat, two foot by six foot, 0.025 gauge rectangular-shaped aluminum panel having twelve prepunched ⅛″ anchoring holes, with the holes spaced vertically at: (1×1); (1×12); (1×23); (71×1); (71×12), and (71×23), and horizontally at: (18×1); (36×1); (54×1); (18×23); (36×23), and (54×23) respectively.

The specialty feature of this device consist of the aluminum panel with a four color ink silk screened tree bark pattern made up with four environmentally safe, non-toxic food color inks to match the bark colors and patterns of the specific tree type. The other specialty feature/consideration is the reproduced “Owl Eyes” simulations painted strategically on the two ends of silk screen. This invention provides a simple, yet effective animal guard for attachment to tree trunks/branches and when added to the visually-aesthetic means allows a single device to be used with a wide range of tree species and their respective bark patterns. At this time, the Honey Locust Tree Bark pattern is available, with other species of tree bark patterns, to follow.

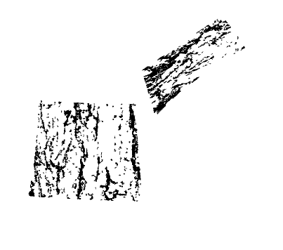

FIG. 3 is a frontal view following the strategic placement on the trunk/branch of a tree to approximately eight to ten feet above ground. Placement for the trunk of the tree is ideally situated just before the first twist or bend in the tree approximately eight feet above ground level. The ideal attachment to the branch is approximately ten feet above ground-level where the branches hang at an angle of 45 degree to 90 degree in relation to ground-level. Again, placement is crucial to fully appreciate the visual appeal, and protective value of this SQUIRREL COMBATON device. For tree trunk placement at the specific height above ground-level, it is suggested that the starter anchors attaching the panel to the tree, on the vertical midline axis of the trunk away from the everyday frontal view, as to make the seam line or area of over-lap less obvious. Branch placement should also be at the optimum height above ground-level, and starter anchors attaching the panel to the tree, on the midline axis of the inferior aspect (the underside of branch) to maximize the continuity of visual appeal and to reduce the footing and gripping action of an animal.

FIG. 4 is a perspective view of the copper/nickel alloy nail used to secure the panel to the living tree. The head of the copper/nickel alloy at the widest point is ¼″ wide. The remainder of the dimensions of the copper/nickel nail are ¾″ long, and ⅛″ in diameter. This alloy type was chosen due to the resistance factor of this alloy to the natural tree acids. This alloy metal is also resistant to the conduction of hot and cold temperatures transmitted by the shaft of the nail through penetration of the living bark of the tree.

### OPERATION

In operation one would attach the printed or its reverse, the non-printed side of the panel, to the tree, at the optimum height and placement, and attach the panel to the tree, using the twelve copper/nickel alloy nails. Starting from bottom to top, left to right, the silk screen pattern on top, facing up, away from the tree, the first of twelve ¾″ copper/nickel alloy anchoring nails are secured to the tree. For tree trunk application, the bottom left (1×1) precut hole would be utilized, at the vertical midline axis of the trunk away from normal frontal view. For tree branch applications, the bottom left (1×1) precut hole would also be utilized, however, the starting point would be on the midline axis of the inferior aspect (the underside of branch). All subsequent starter anchoring of panel to tree trunk/branch are at precut holes (1×12), followed by (1×23). At this point, the printed panel is then curled around the trunk/branch, securing both top and bottom of panel to tree, as curling and anchoring continue, with one copper/nickel alloy nails, at precut holes: (18×1), (18×23); (36×1), (36×23); (54×1), (54×23) and finally, (71×1), (71×12), and (71×23) or until the tree trunk/branch circumference is totally shielded with the panel. More over, removal of panel from tree trunk or branch is simply, just reversing the attachment instructions above.

Once the SQUIRREL COMBATON device is in place, nothing else is required to be done. This device can provide a 24 hour/7 day a week protection against squirrels and other tree nesting animals.

As was suggested placement is critical for maximum protection of this device for this animal type. On the same token, this device, dependent upon height of placement on the tree, can also be utilized against other domesticated and wild animals. Some of the other alternative applications for this device is the prevention of tree damage caused by grazing animals, such as cattle or deer. When forging for food, it is not uncommon for this type of range species to mark their territory by rubbing their face area or torso against objects in their immediate area, in this case, trees. Damage from dogs and cats marking or spraying territory scents at the base the tree can also be included in the height of placement category.

1. It is, therefore, a claim of this invention that it will provide a non-lethal. Humane combined, above and at ground level barrier animal guard for tree trunks/branches. This device will provide a visually aesthetic means that allow protection of trees while disrupting little of the natural beauty of the tree. The shielding is to be coordinated to the specific tree bark design and Colorado to match that specific tree species. Therefore, location of the panel(s) can be either at ground level or above ground.
A claim of this invention is to provide an animal guard for attachment to tree trunks/branches which is provided with a four color ink silk screened representation of a distinctive tree pattern design that allows a single device to be used with a wide range of tree species and their bark designs. In addition, we will be introducing the “Our Byes Logo” design strategically on the panels.
It is another claim of this invention to effectively reduce the footing and gripping action of an animal attempting to overcome such a barrier by utilizing a smooth metal panel with colors and patterns of tree area matching the protected area of the tree.
A further claim of this invention is to provide a relatively simple and easily attached device that ban be left on year round, and does not hurt the growth of the tree.
Another claim of this invention is that it offers adjustable fit, and can accommodate a variety of tree girths, in six foot sections and is very low maintenance, yet weather proof and durable. It will also be functional at ground level, as well as above ground level, which ever the user chooses.
